(19) United States
(12) Patent Application Publication
(10) Pub. No.: US 2005/0135794 A1
(43) Pub. Date: Jun. 23, 2005

(54) Method and system for negative torque reduction in a brushless DC motor

(75) Inventors: Pradeep Vijayan, Bangalore (IN); Amit Sanglikar, Bangalore (IN); Ajit Kane, Bangalore (IN)

Correspondence Address: General Electric Company;CRD Patent Docket Rm 4A59, P.O. Box 8, Bldg. K-1, Schenectady, NY, 12301, US

(73) Assignee: General Electric Company

(21) Appl. No.: 10/743,199

(22) Filed: Dec. 22, 2003

(51) Int. Cl. H02P 5/00

(52) U.S. Cl. 388/800; 388/934

(57) ABSTRACT

A method for reducing negative torque in a brushless single phase DC motor, the method includes initiating the motor in a normal mode of operation and activating an ON time control to cut off a voltage supply to the motor. The ON time control is applied after a predetermined time delay, the delay being defined by the motor parameters.

### BACKGROUND OF THE INVENTION

The invention relates generally to brushless DC motors and more specifically to methods and systems to control negative torque and provide variable speed control in a brushless DC motor.

A brushless DC motor typically has a stator with a plurality of teeth and a rotor with permanent magnets mounted on it. When wire-wound coils on the teeth are energized with current, the stator and rotor interact to produce positive or negative torque, depending on the direction of the current with respect to the polarity of the magnets. In motors of this type, an electronic inverter bridge controls energization of the stator winding for controlling the direction and amount of torque produced by the motor as well as for controlling the rotor shaft speed. The inverter bridge typically has a number of power switching devices for connecting the motor's winding or windings to a power supply.

The negative torque produced by the brushless DC motor is essentially due to the motor inductance. Once the rotor pole is past the magnetic neutral axis of the stator, the stator pole polarity has to be reversed. This reversal is done by reversing the current through the stator windings, by means of turning off or on a pair of power switching devices. Due to the motor inductance, it takes a certain amount of time for the current in the motor windings to reverse direction. Additionally, the amount of time for current reversal depends on the DC bus voltage and the magnitude of current. Due to the delay in current reversal (and hence delay in stator pole polarity reversal), the stator pole ‘pulls back’ the rotor pole instead of propelling it forward. This gives rise to production of negative torque, which will cause a deceleration of rotor as well as stress and vibrations in the mechanical assembly.

Some of the techniques being used for reducing negative torque include conduction angle control, current mode control (peak current control or average current control or hysterisis current control with low inductance motor), and advancement of position sensor along with a square wave control. These have some inherent limitations, for example, conduction angle control needs expensive microcontroller/DSP/ASIC for implementation. Current mode control works only with specially designed low inductance motors and to achieve the same torque level as a voltage mode motor, the current through the current mode motor has to be much higher. This results in higher losses in semiconductor devices and use of higher rating devices. Position sensor advancement usually works well only for a certain speed and is non-optimal for other speeds of operation

It would therefore be desirable to have a system and a method for controlling the negative torque in a brushless DC motor, which is simple, inexpensive and easy to implement.

### BRIEF DESCRIPTION OF THE INVENTION

Briefly, in accordance with one aspect, a method for reducing negative torque in a brushless single phase DC motor is provided. The method includes initiating (or starting) the motor in a normal mode of operation and activating an ON time control to cut off a voltage supply to the motor. The ON time control is applied after a predetermined time delay, the delay being defined by the motor parameters.

In accordance with another aspect, a system for controlling negative torque in a brushless DC motor is provided. The system includes a positional sensor for producing a sensor signal based on polarity of a rotor of the motor and a control circuitry for activating an ON-time control to cut-off a voltage supply to the motor, the activating of the ON-time control is synchronized with an edge of the sensor signal.

### BRIEF DESCRIPTION OF THE DRAWINGS

The foregoing and other advantages and features of the invention will become apparent upon reading the following detailed description and upon reference to the drawings in which:

FIG. 1 is a diagrammatic view of a system for controlling negative torque in a brushless DC motor;

FIG. 2 is a set of waveform diagrams depicting the voltage flow and a negative torque in absence of ON time control and corresponding waveforms for voltage and torque using ON time control;

FIG. 3 is a diagrammatic view of an HVAC system using the ON time control for operating at variable speeds;

FIG. 4 is a flowchart depicting a method for controlling negative torque in the systems of FIG. 1 and FIG. 3; and

FIG. 5 is a flowchart depicting the method of applying ON time control.

### DETAILED DESCRIPTION OF SPECIFIC EMBODIMENTS

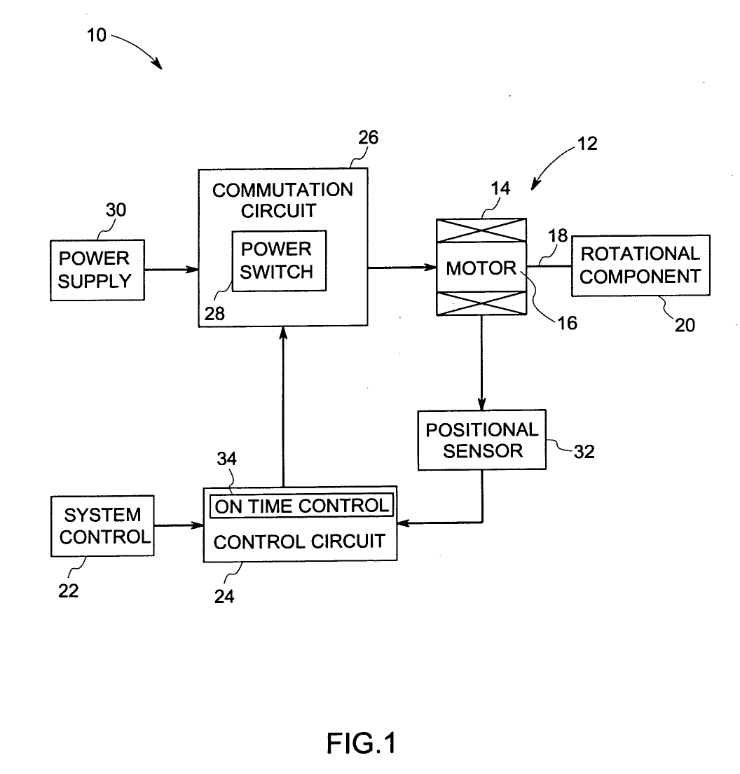

Referring now to the drawings, FIG. 1 shows a motor system 10 including a brushless DC motor, generally designated 12, having a stationary assembly, or stator, 14 and a rotatable assembly, or rotor, 16 in magnetic coupling relation to the stator 14. In the embodiments described herein, motor 12 may be an electronically commutated motor. It is to be understood, however, that aspects of the present invention may be applied to any single phase or poly phase brushless DC machine and switched reluctance motors. In addition, the motors may have a single split phase winding or a multi-phase winding. Such motors may also provide one or more finite, discrete rotor speeds selected by an electrical switch or other control circuit.

A motor shaft 18 mechanically connects the rotor 16 to a particular device to be driven, such as a rotatable component 20. For example, the rotatable component 20 comprises a fan, blower, compressor or the like for use in a heating, ventilating and air conditioning system or refrigeration system. Although motor 12 is particularly useful for driving a fan, it is to be understood that motor 12 may be part of a number of different systems for driving other rotatable components. In addition, rotatable component 20 may include a connection mechanism for coupling it to the shaft 18.

A user interface, or system control, 22 provides system control signals to a control circuit 24. The system control signals take the form of motor commands representing, for example, turn on and turn off commands, desired fan speeds and the like. In response to the system control signals, the control circuit 24 then generates motor control signals. As represented by the block diagram of FIG. 1, control circuit 24 provides the control signals to the commutation circuit 26 for electronically controlling switching of a plurality of power switches 28, such as insulated gate bipolar transistors, bipolar junction transistors or metal oxide silicon field effect transistors. As would be understood by those skilled in the art, gate drives may be used, as an interface between the signal from the control circuit 24 and the commutation circuit 26, to provide sufficient voltage (e.g., 15 volts) for driving the power switches 28 and for conditioning the signals provided by control circuit 24 for optimal operation of power switches 28.

A power supply 30 provides high voltage DC power to switches 28. Power switches 28 then provide power to motor 12 by selectively switching the power supply 30 in connection with the motor winding(s) (not shown) included in stator 14.

Referring further to FIG. 1, a position sensor 32 provides control circuit 24 with a feedback signal that is representative of an angular position of rotor 16 relative to stator 14. In general, the position signal has a predefined angular relationship relative to the motor back electromagnetic field, which permits an estimation of rotor position. In a specific example position signal is in phase with the back electromagnetic field. It would be appreciated by those skilled in the art that the position signal may be phase advanced also. Position sensors, such as one or more Hall sensors or optical sensors, may be used to provide rotor position feedback.

Power switches 28 energize the motor winding in a preselected sequence for commutating motor 12 in response to control circuit 24. The preselected sequence, as would be appreciated by those skilled in the art, depends on the positional sensor signal. In this instance, control circuit 24 selectively activates power switches 28 to control rotation in motor 12 as a function of the motor control signals. It is to be understood that power supply 30 may also provide power to operate control circuit 24.

The control circuit 24 generates its control signals as a function of the estimated zero crossings of the back electromagenteic field of motor windings. As is generally known in the art, the product of the current and the back electromagnetic field determines torque production in motor 12, and in conventional systems, the motor 12 develops considerable amount of negative torque when under normal operation. In one example, a square wave mode of operation is used for initiating the motor 12. Under square wave mode of operation, the position sensor signal is used directly, without any modifications, to control the motor voltage. For example, if the position sensor signal is ‘high’, motor gets+ve voltage and when the position sensor signal is ‘low’ the motor gets−ve voltage. To overcome the negative torque produced under normal square wave mode operation, the control circuit 24 includes an ON time control 34 which is turned on after a predetermined time delay after the motor is started under normal operation. ON time control is not activated right at start of the motor, because the ON time control employs fixed time duration pulses. When motor is stationary, these fixed time duration pulses will not be enough for the motor to start rotating. However once the motor speed has picked up, these pulses are sufficient to maintain the rotating motion. The predetermined time delay depends on the motor specification and also on load conditions. In an exemplary embodiment, a half HP (Horse Power) i.e approx. 340 Watts brushless DC motor was used and the ON time control was switched on after 10 seconds. Once the ON time control 34 is activated, the voltage (power) supply to the motor 12 is cut-off and the motor is allowed to run at the desired speed. The ON time control 34 is embodied in one example, by a low cost analog circuitry using for example a timer integrated circuit, a comparator and logic gates.

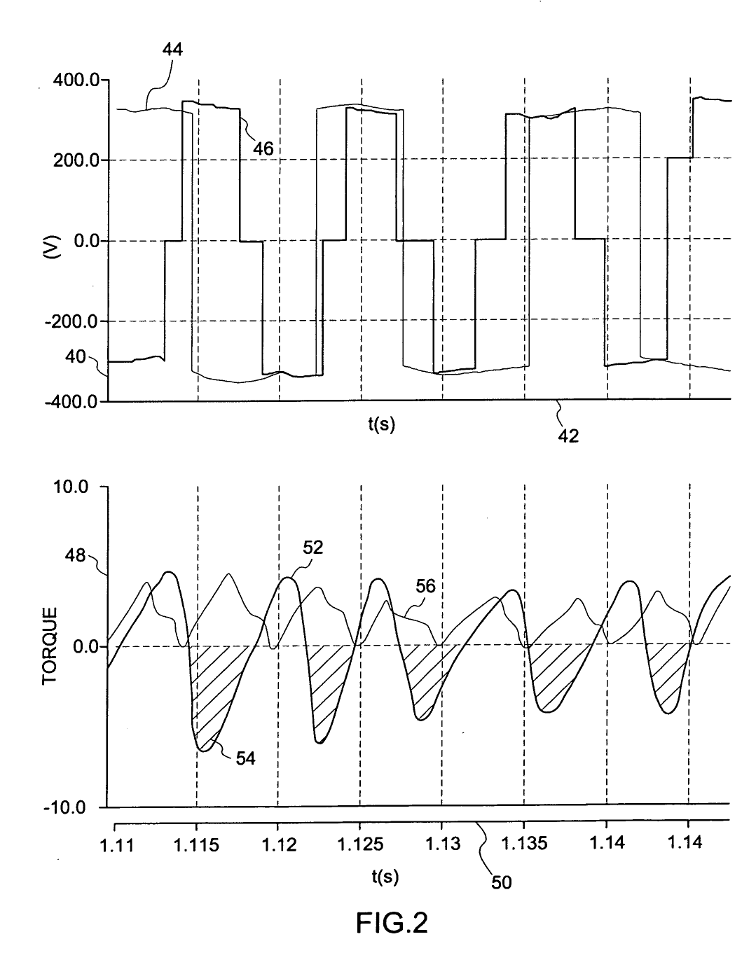

The positive torque is sustained by the use of ON time control 34 since the motor winding is now energized when the back electromagnetic field has crossed zero in the direction that will oppose the voltage energizing them. Since the voltage supply is cut-off, the current through motor 12 towards end of each cycle will reduce, and this aids the motor current to build rapidly in the reverse direction when a voltage of opposite polarity is applied during the next half cycle through the commutation circuit 24. FIG. 2 illustrates the comparative waveform diagrams for the applied voltage supply and torque produced for a motor 12 operated under normal mode and under ON time control. Voltage in ‘volts’ is depicted on the axis 40 and corresponding time in ‘seconds’ on the axis 42. Similarly, reference numeral 48 depicts the axis showing torque produced and the corresponding axis 50 depicts time duration for the torque in ‘seconds’. Reference numeral, 44 depicts the graphical representation of the voltage applied through control circuit 24 to the motor 12 operating without the ON time control. The graph generally represented by reference numeral 52 depicts the corresponding torque produced, when the ON time control is not used, the hatched portion 54 showing the negative torque portion. In contrast, reference numeral 46 depicts the voltage applied by using the ON-time control and reference numeral 56 depicts the corresponding torque produced using the ON time control. As is clear from the graphical representation, no negative torque is produced when the ON time control is used.

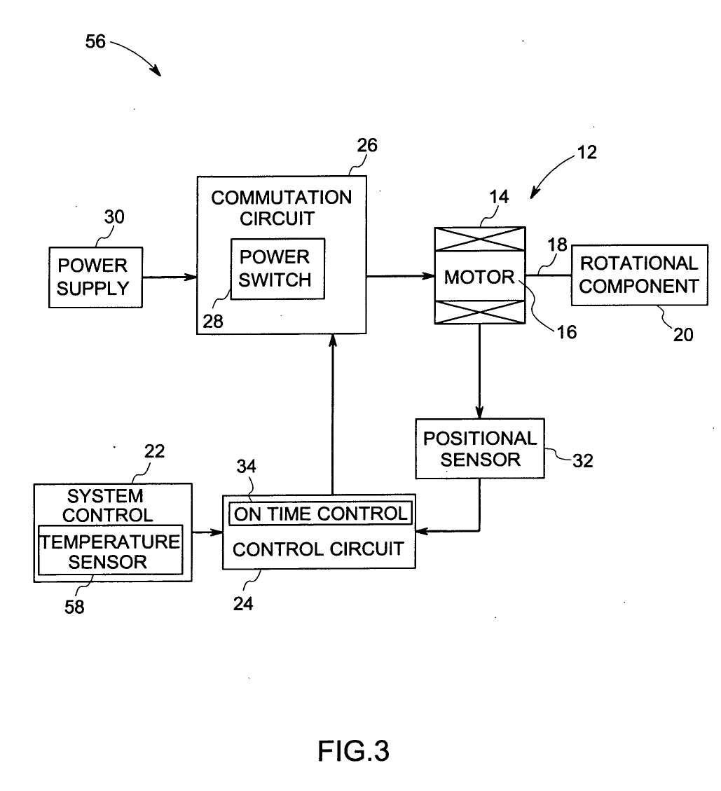

FIG. 3 illustrates a specific application for the motor 12 as described hereinabove. A HVAC system 57 includes a single phase brushless DC motor 12 with an ON time control 34 for varying a speed of the motor 12 based on a plurality of temperature measurements. The system 36 includes a temperature sensor 58 for measuring an ambient temperature. In operation, control circuit 24 triggers signals that define desired commutation intervals based on the system control 22 signals. The system control signals are a response to each of plurality of temperature measurements. These signals, as would be appreciated by those skilled in the art may be triggered in response to other motor control command signals, or commutation, and cause power switches 28 to switch. The resulting motor current preferably matches the load torque demand as a function of a regulated current reference level. By matching torque load with produced torque, motor 12 is able to operate at a desired torque or speed. The current in motor winding produces an electromagnetic field for rotating the rotor 16 of motor 12. To control the speed of rotatable component 20, system 36 controls the power delivered to the load to control the speed of motor 12. In particular, system 56 regulates the ON time control 34, which in turn regulates the negative torque, to obtain the desired motor speed corresponding to each one of the plurality of the temperature measurements. As would be appreciated by those skilled in the art, the ON time control can be manual or alternately it can be automatic.

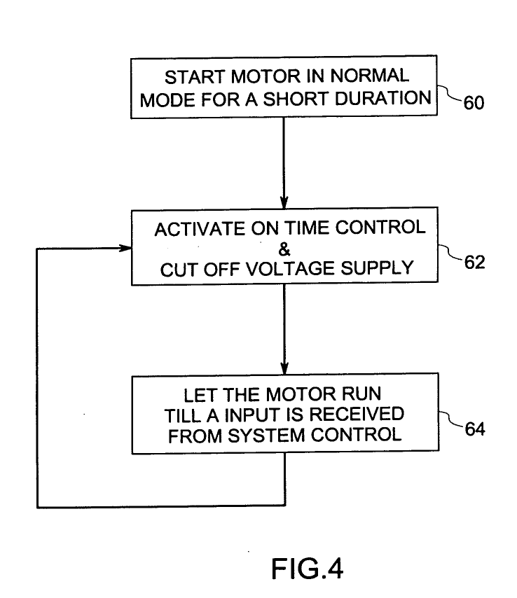

FIG. 4 illustrates a flowchart encompassing the method for controlling the negative torque in a motor, particularly in a brushless single phase DC motor 12 of FIG. 1 (or alternatively FIG. 3). The method includes a step 60 of initiating the motor 12 in normal mode for a short time interval (which is a predetermined time delay). Next, after the predetermined time delay, at step 62, the ON time control is activated which cuts-off the voltage supply to the motor 12. The time delay, as would be appreciated by those skilled in the art will be dependent on motor parameters like inductance, the DC bus voltage, the speed of rotation and also the load conditions. Next at step 64, the motor is allowed to run for a duration which is dependent on the desired motor speed, alternatively the system control may send in a signal for changing the speed and the ON time control is varied to obtain the next desired speed of operation.

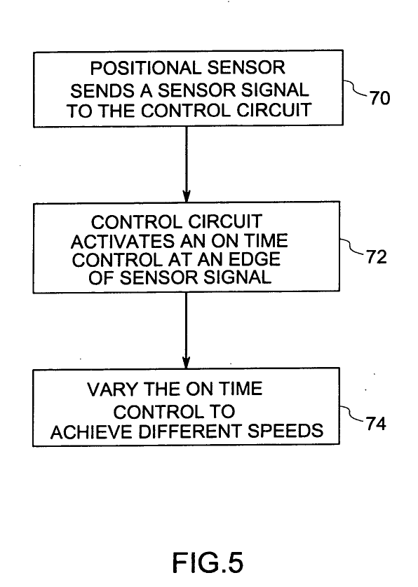

FIG. 5 illustrates a flowchart depicting in detail the step 62 of FIG.4. At step 70 the control circuit 24 receives a sensor signal from a positional sensor 32 based on polarity of rotor 16 for commuting the motor 12 by controlling a plurality of power switches 28. At step 72, the control circuit 24 synchronizes the activation of the ON time control 34 with an edge of the sensor signal. At step 74, the ON-time control is varied to achieve a plurality of speeds of operation for the motor 12. In one example, the required speed of operation corresponds to a discrete speed. In another example, the required speed of operation corresponds to a continuous range of speeds.

As would be appreciated by those skilled in the art, the negative torque reduction methods and systems as described in above embodiments will be advantageous for a variety of applications including but not limited to high ventilating air conditioning (HVAC), refrigeration equipments, home appliances like vacuum cleaners, washing machines and in air filtration systems.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for reducing negative torque in a brushless single phase DC motor, the method comprising:
initiating the motor in a normal mode of operation; and
activating an ON time control to cut off a voltage supply to the motor,
wherein the ON time control being applied after a predetermined time delay defined by the motor parameters.

2. The method of claim 1 further comprising:
using a positional sensor for producing a sensor signal based on polarity of a rotor of the motor; and
using the sensor signal for controlling a plurality of switches for commutation of the motor.

3. The method of claim 2, wherein the activating of the ON time control is synchronized with an edge of the sensor signal.

4. The method of claim 1 further comprising varying the ON time control (34) to achieve a plurality of speeds of operation for the motor.

5. The method of claim 1, wherein duration of the ON time control is predetermined based on a required speed of operation.

6. The method of claim 5, wherein the required speed of operation corresponds to a discrete speed.

7. The method of claim 5, wherein the required speed of operation corresponds to a continuous range of speeds.

8. A system for controlling negative torque in a brushless DC motor, the system comprising:
a positional sensor for producing a sensor signal based on polarity of a rotor of the motor; and
a control circuitry for activating an ON-time control to cut-off a voltage supply to the motor,
wherein the activating of the ON-time control is synchronized with an edge of the sensor signal.

9. The system of claim 8 further comprising a commutation circuitry, wherein the commutation circuitry uses the sensor signal for controlling a plurality of switches for commutation of the motor.

10. The system of claim 8, wherein the ON-time control is varied to achieve a plurality of speeds.

11. The system of claim 8, wherein a duration of the ON time control is defined by the motor parameters.

12. The system of claim 8, wherein the duration of ON time control is predetermined based on a required speed of operation.

13. The system of claim 8, wherein the required speed of operation corresponds to a discrete speed.

14. The system of claim 8, wherein the required speed of operation corresponds to a continuous range of speeds.

15. A HVAC system comprising:
a single phase brushless DC motor with an ON time control for varying a speed of the motor based on a plurality of temperature measurements; and
at least one temperature sensor for measuring an ambient temperature.

16. The system of claim 15, wherein the speed of the motor is varied corresponding to each one of the plurality of the temperature measurements.

17. The system of claim 15, wherein the ON time control is manual.

18. The system of claim 15, wherein the ON time control is automatic.

19. The system of claim 15, wherein the ON time control cuts off voltage supply to the motor.
